(19) United States
(12) Patent Application Publication
(10) Pub. No.: US 2015/0122199 A1
(43) Pub. Date: May 7, 2015

(54) MULTIFUNCTION DOG TRAINING COLLAR

(71) Applicant: Todd Koplin, South Jordan, UT (US)

(72) Inventor: Todd Koplin, South Jordan, UT (US)

(21) Appl. No.: 14/595,115

(22) Filed: Jan. 12, 2015

Related U.S. Application Data
(63) Continuation-in-part of application No. 14/294,436, filed on Jun. 3, 2014, now abandoned.
(60) Provisional application No. 61/830,488, filed on Jun. 3, 2013.

(51) Int. Cl. A01K 15/02; A01K 27/00

(52) U.S. Cl. CPC A01K 15/023; A01K 15/022; A01K 27/001; A01K 27/009
USPC 119/718; 119/721; 119/720

(57) ABSTRACT

A multifunction dog training collar for pet behavior modification is provided. The collar may operate in multiple modes including a remote training mode, a confinement mode, and an anti-bark mode. In the remote training mode, a dog trainer may use a hand-held remote to apply a stimulus to correct misbehavior. In the confinement mode, the collar will apply a stimulus when the dog approaches or crosses a pre-defined boundary. In the anti-bark mode, the collar will apply a stimulus when the dog barks.

### CROSS-REFERENCE TO RELATED APPLICATIONS

This application is a continuation-in-part of U.S. patent application Ser. No. 12/294,436 filed on Jun. 3, 2014, and entitled MULTIFUNCTION DOG TRAINING COLLAR, which application claims the benefit of U.S. Provisional Application No. 61/830,488, filed Jun. 3, 2013, and entitled MULTIFUNCTION DOG TRAINING COLLAR, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Present Disclosure

The present disclosure relates generally to animal training devices, and more particularly, but not necessarily entirely, to electronic dog training collars.

2. Description of Related Art

Electronic dog training collars have been known in the art. In one instance, a dog trainer uses a hand-held transmitter that is able to send a radio signal to a receiver module attached to a collar around the dog's neck. The radio signal may cause the collar to apply a stimulus, such as a shock, vibration, or audio warning. Other types of collars are useful for preventing a dog from barking. These anti-bark collars may include a bark sensor such that when the dog barks, the collar immediately applies a stimulus to deter future barking. Still other types of collars are useful for keeping a dog confined within a predefined boundary. These types of collars apply a stimulus if the dog approaches a pre-determined boundary. What is lacking in the prior art, however, is a multifunction dog collar that is able to allow remote training, bark prevention and boundary confinement in a single unit.

The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a dog collar according to an embodiment of the present disclosure;

FIG. 2 is a diagram of a remote training unit and the collar shown in FIG. 1 around the neck of a dog;

FIG. 3 depicts a dog wearing the collar shown in FIG. 1 in a pre-defined confinement area;

FIG. 4 depicts a dog wearing the collar shown in FIG. 1;

FIG. 5 is a block diagram of the remote training unit shown in FIG. 2 according to an embodiment of the present disclosure;

FIG. 6 is a block diagram of the training collar shown in FIG. 1 according to an embodiment of the present disclosure;

FIG. 7 is a block diagram of a hand-held receiver according to an embodiment of the present disclosure;

FIG. 8 is a block diagram of a collar according to an embodiment of the present disclosure;

FIG. 9 is a flow diagram according to an embodiment of the present disclosure; and

FIG. 10 is a block diagram of a collar according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. It must be noted that, as used in this specification and the appended claims, the singular forms “a,” “an,” and “the” include plural referents unless the context clearly dictates otherwise. As used herein, the terms “comprising,” “including,” “containing,” “having,” “characterized by,” and grammatical equivalents thereof are inclusive or open-ended terms that do not exclude additional, unrecited elements or method steps.

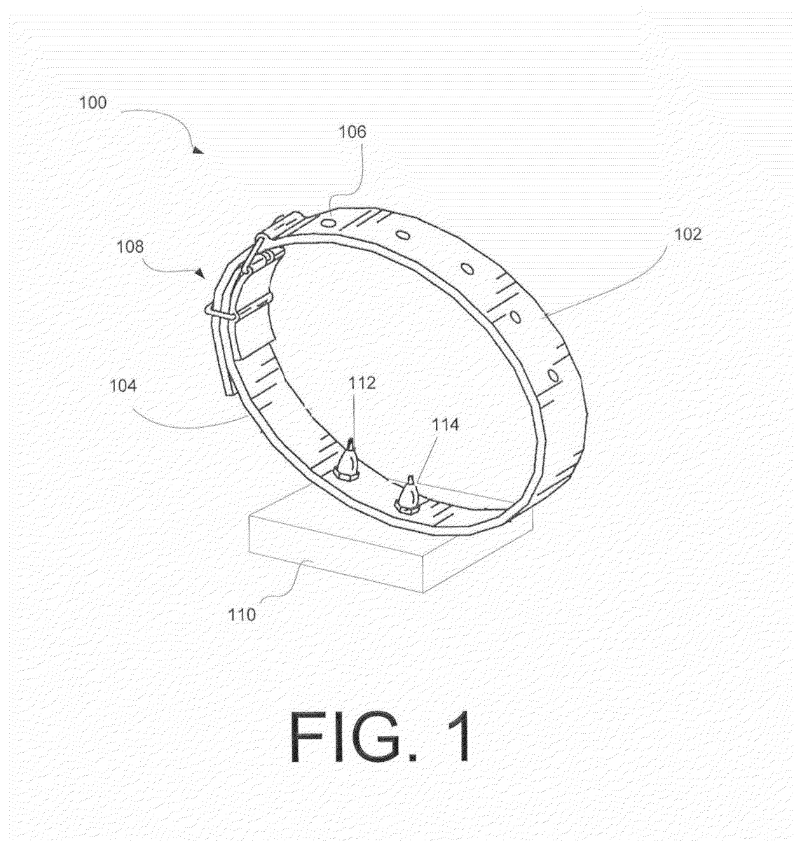

Referring now to FIG. 1, there is depicted a dog collar 100 according to an embodiment of the present disclosure. It will be appreciated that the collar 100 may be utilized on other types of animals. The dog collar 100 may be sized to accommodate different sized dogs, including large breeds, medium breeds, and small breeds.

The collar 100 may include a strap 102 having a first end 104 and a second end 106. In an embodiment, the strap 102 may be constructed of leather, plastic, or some other suitable material.

The first end 104 and the second end 106 of the strap 102 may be connected using a buckle assembly 108. It will be appreciated that the buckle assembly 108 may be replaced with some other device, including a clip, velcro, or any other means. The strap 102 may be adjustable to fit around different sized necks of animals of varying sizes.

A housing 110 may be attached to an outer surface of the strap 102. In an embodiment, the housing 110 may include two or more parts that are joined together to form the housing 110. In an embodiment, the parts are sealed using a gasket material. The housing 110 may be waterproof. In an embodiment, the housing 110 is formed from plastic.

Extending from the housing 110, and through the strap 102, is a pair of electrical probes 112 and 114. The electrical probes 112 and 114 may deliver an electrical stimulus, i.e., a brief shock, to the dog for training purposes as will be discussed in further detail below.

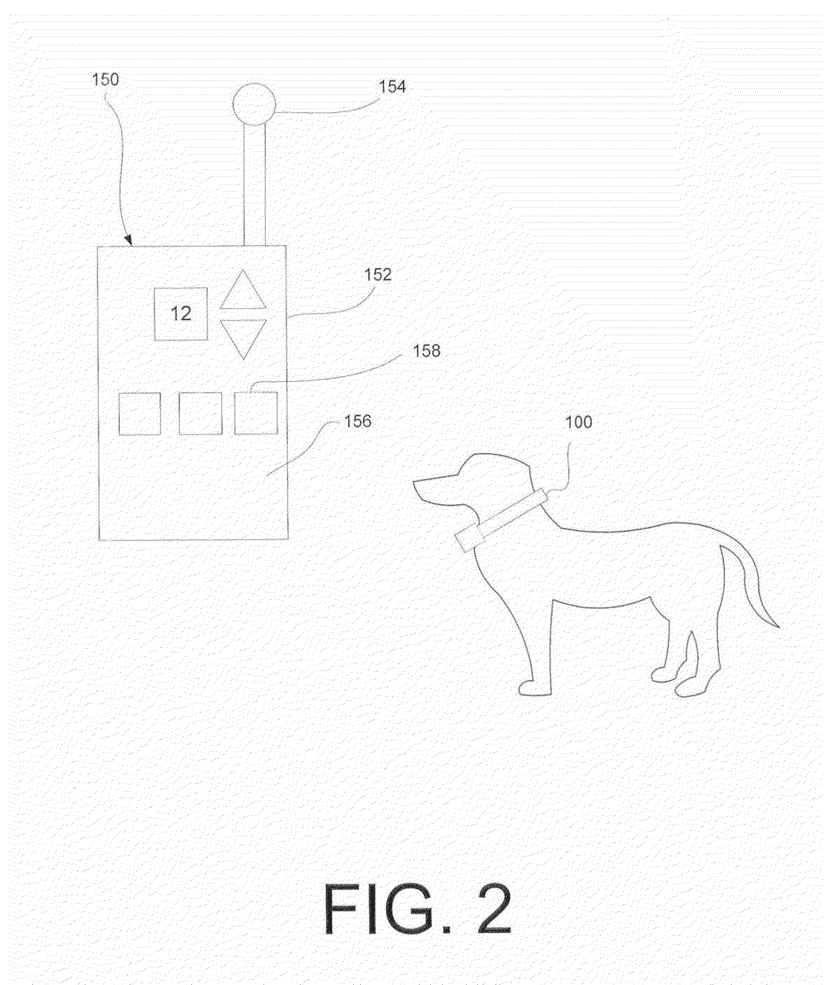

Referring now to FIG. 2, a hand-held remote 150 may be utilized by a dog trainer to send wireless command signals to the collar 100. In particular, the remote 150 may include a housing 152. In an embodiment, an antenna 154 may extend from the housing 152. A face 156 of the housing 152 may have a plurality of user controls 158. The user controls 158 may include buttons, switches, wheels, touch screen, joy sticks, or any other user controls adapted to receive user input.

The user controls 158 may allow a dog trainer to send command signals to the collar 100. The control signals may cause the collar 100 to apply a stimulus. In an embodiment, the stimulus may include an electric shock, a vibration, or an audible warning. The user controls 158 may also allow the dog trainer to adjust a stimulus level, e.g., increase or decrease a duration or strength of a stimulus.

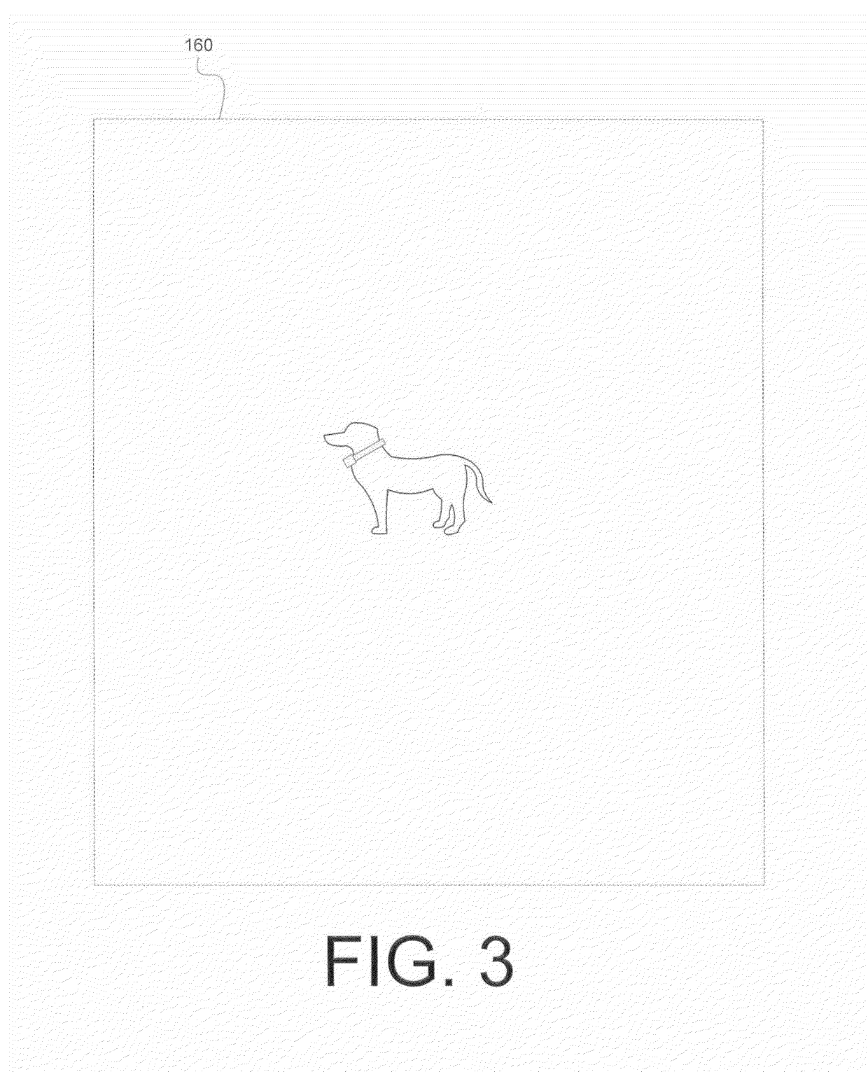

Referring now to FIG. 3, there is depicted the collar 100 on a dog positioned within a pre-defined boundary 160, known as a wireless fence. In an embodiment, the boundary 160 may be established by an underground wire that emits a radio signal. In an embodiment, the boundary 160 may be established by GPS coordinates entered into the collar 100. In an embodiment, the boundary 160 may be established by directional radio signals. In an embodiment, the boundary 160 may be established by light signals.

It will be appreciated that the boundary 160 is a wireless fence. When the dog approaches the boundary 160, the collar 100 automatically provides a stimulus. In an embodiment, the stimulus may be one of an electrical shock, a vibration, or an audible warning. In an embodiment, the collar 100 may provide a first stimulus as the dog approaches the boundary 160 as a warning and a second stimulus when the dog actually crosses the boundary 160. In an embodiment, the first stimulus may be a vibration or audible stimulus while the second stimulus may be an electrical shock. In this manner, the dog receives a warning prior to actually crossing the boundary 160. Overtime, the dog will learn the location of the boundary 160.

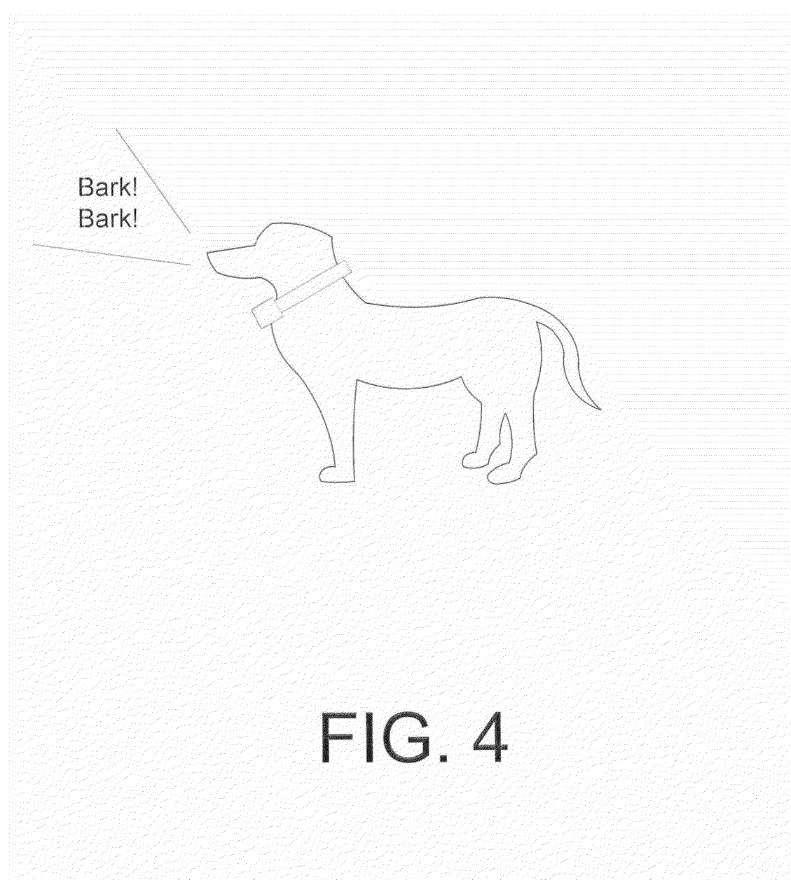

Referring now to FIG. 4, there is depicted the collar 100 on a dog. The collar 100 may include a no-bark feature that suppresses the dog's desire to bark. In particular, when the dog barks, the collar 100 detects the bark and provides a stimulus. In an embodiment, the stimulus may be one of an electrical shock, a vibration, or an audible warning. In an embodiment, the stimulus may be user selectable.

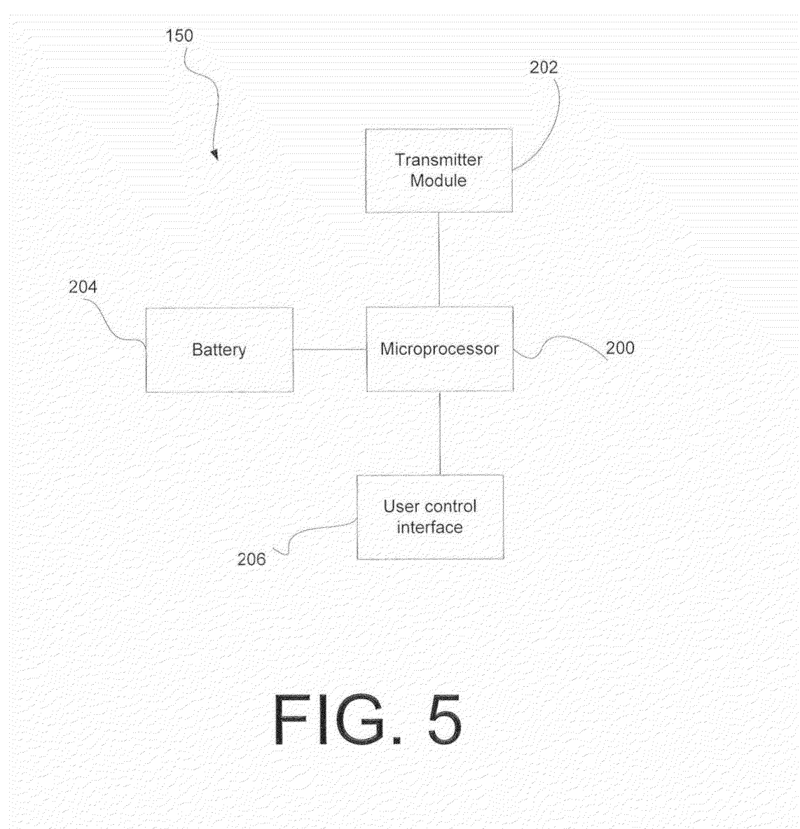

Referring now to FIG. 5, there is depicted a block diagram of the electronics of the remote 150 shown in FIG. 2 according to an embodiment. The remote 150 may include a microprocessor 200. A battery 204 may provide power to the microprocessor 200 as well as the other components of the system. The remote 150 may further comprise a user control interface 206 for interfacing with the user, i.e., the dog trainer. For example, the dog trainer may manually actuate buttons which sends a signal from the user control interface 206 to the microprocessor 200.

The microprocessor 200 may interpret the control signals to send the appropriate commands to the collar 100. The microprocessor 200 may be connected to a transmitter module 202. The transmitter module 202 may configure and modulate the command signals for radio transmission through the antenna 154.

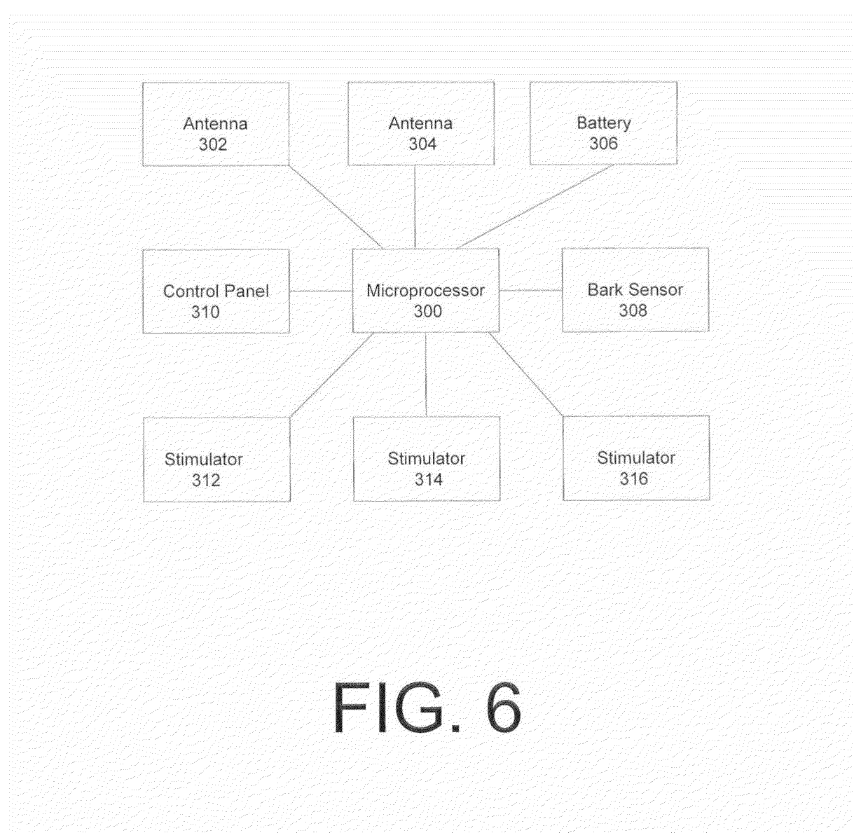

Referring now to FIG. 6, there is depicted a block diagram of the electronics of the collar 100 according to an embodiment of the present disclosure. The collar 100 may contain a microprocessor 300. The collar 100 may further include an antenna 302 for receiving radio signals from the remote 150 shown in FIG. 2. The collar 100 may further include an antenna 304 for receiving signals from a buried wire that forms part of a wireless fence. In an embodiment, the antenna 304 may be utilized to receive GPS signals from satellites in order to determine a position of the dog wearing the collar 100. In an embodiment, the antenna 304 may be adapted to receive signals from a radio transmitter. The collar 100 may further include a re-chargeable battery 306 for powering the components of the collar 100 as is known to one having ordinary skill.

The collar 100 may further include a bark sensor 308. The bark sensor 308 may detect barks from a dog wearing the collar 100. The collar 100 may further include stimulators 312, 314, and 316. In an embodiment, the stimulator 312 may administer an electric shock through electrodes 112 and 114 shown in FIG. 1. In an embodiment, the stimulator 314 may be a vibrator. In an embodiment, the stimulator 316 may administer an audible warning through a speaker.

The control panel 310 may allow a dog trainer to set an operation mode of the collar 100. For example, the collar may have multiple modes to allow a dog trainer to turn off or on any of the features. For example, the training mode, the anti-bark mode, and the confinement mode may be turned off or on in any combination. Each of these modes are explained below.

Remote Training Mode:

In the remote training mode, a dog trainer with the remote 150 may send command signals to the collar 100 when the dog misbehaves. The signals may include a command for the collar 100 to apply a stimulation for training purposes. In an embodiment, the stimulation may be one of a small electric shock, a vibration, and an audible warning. The dog trainer may select the type of stimulation at the remote 150. In addition, the dog trainer may be able to set the intensity level and/or duration of the stimulation at the remote 150.

The dog trainer may apply the stimulation by actuating a button on the remote 150. The remote 150 may have a range up to, or greater than, one-half of a mile.

Confinement Mode:

In confinement mode, the collar 100 may apply a stimulation when the dog approaches or crosses the pre-defined boundary 160. In an embodiment, the boundary 160 may be defined by a wire buried in the ground and that emits a radio frequency signal. In an embodiment, the boundary 160 may be established by GPS coordinates programmed into the collar 100. In this case, the collar 100 may include a GPS receiver. In an embodiment, the boundary 160 may be established by radio, infrared, beacons, or some other signal.

Anti-Bark Mode

In anti-bark mode, the collar 100 may apply a stimulation when the dog barks. In an embodiment, the stimulation may be applied after a pre-set number of barks. The dog trainer may set the stimulations to incur in a pre-defined order. For example, after the first bark the collar 100 may provide an audible stimulation. After the second bark, the collar 100 may provide a vibration stimulation. After the third bark, the collar 100 may provide an electric shock stimulation.

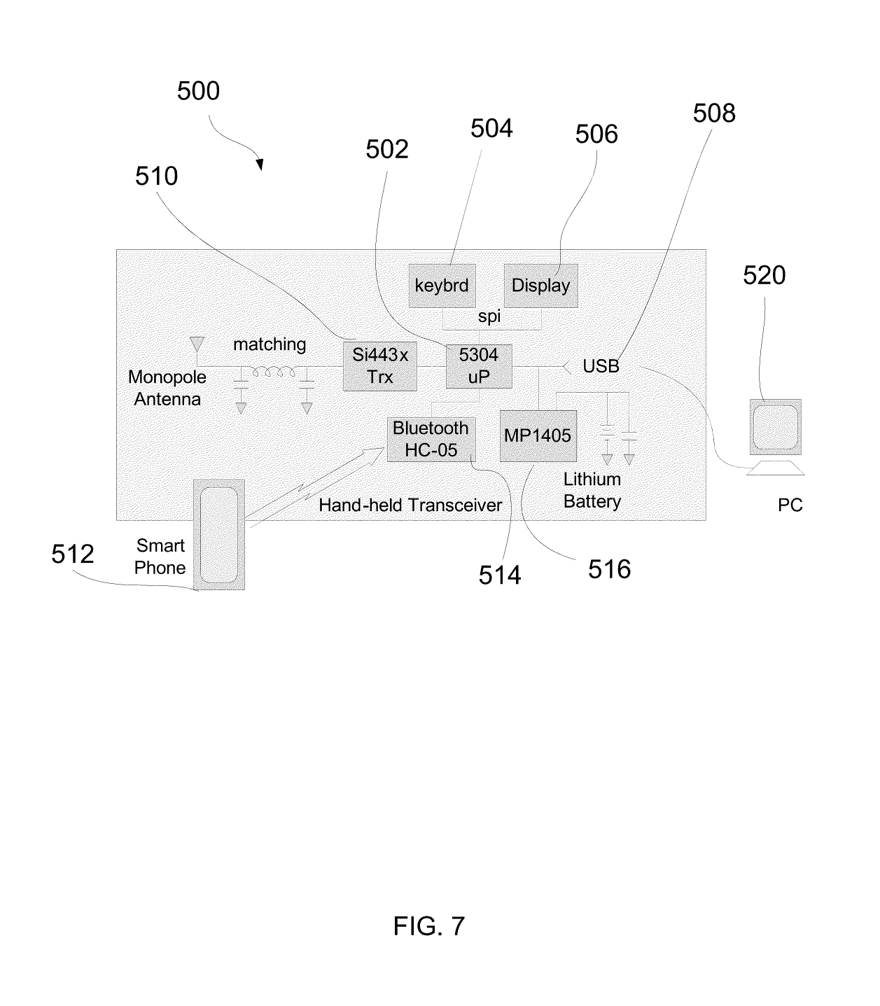

Referring now to FIG. 7, there is depicted a block diagram of a hand-held transceiver device 500 according to an embodiment of the present disclosure. In an embodiment, the device 500 may include microprocessor 502. A keyboard 504 for receiving user input may be connected to the microprocessor 502. An electronic display 506 for displaying system information to the user may also be connected to the microprocessor 502. A transmitter chipset 510 may be connected to the microprocessor 502. The circuit 510 may include an antenna. A blue tooth chipset 514 may be connected to the microprocessor 502. The blue tooth chipset 514 may allow the device 500 to connect with blue tooth enabled devices, such as a smart phone 512. A charging circuit 516 may be connected to a battery. In an embodiment, the device 500 may include a USB port for connected the device 500 to a computer 520 and for charging the battery.

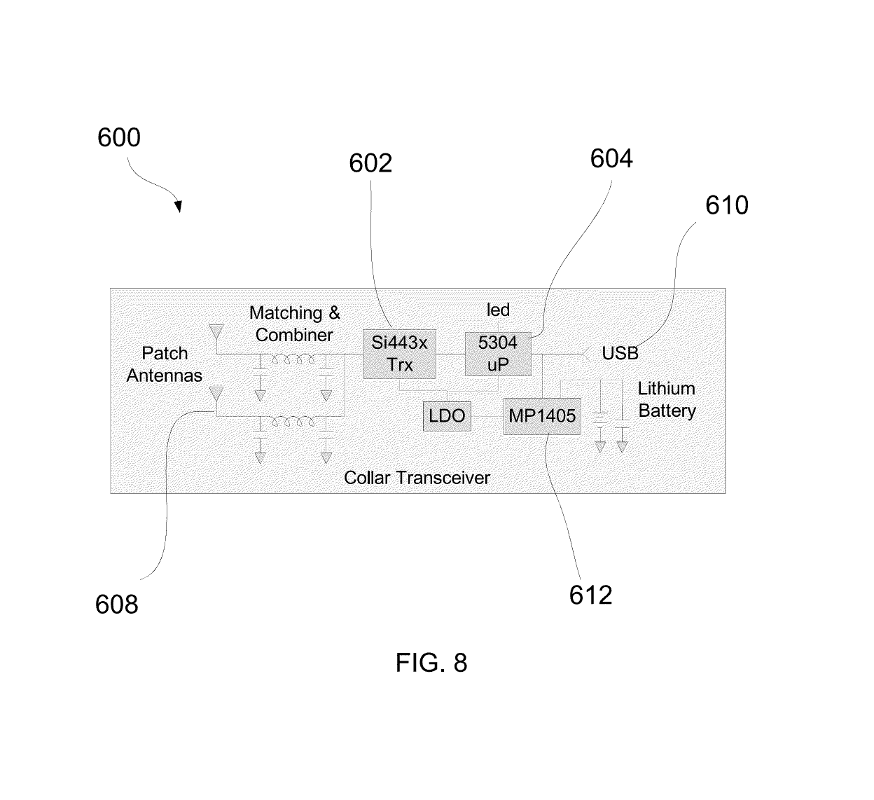

Referring now to FIG. 8, there is depicted a block diagram of a collar transceiver 600 according to an embodiment of the present disclosure. The transceiver 600 may include a microprocessor 604. The transceiver 600 may further include a transmitter chipset 602 coupled to patch antennas 608. The transceiver 600 may include a charging circuit 612 for charging a battery. The transceiver 600 may include a USB port for charging the battery.

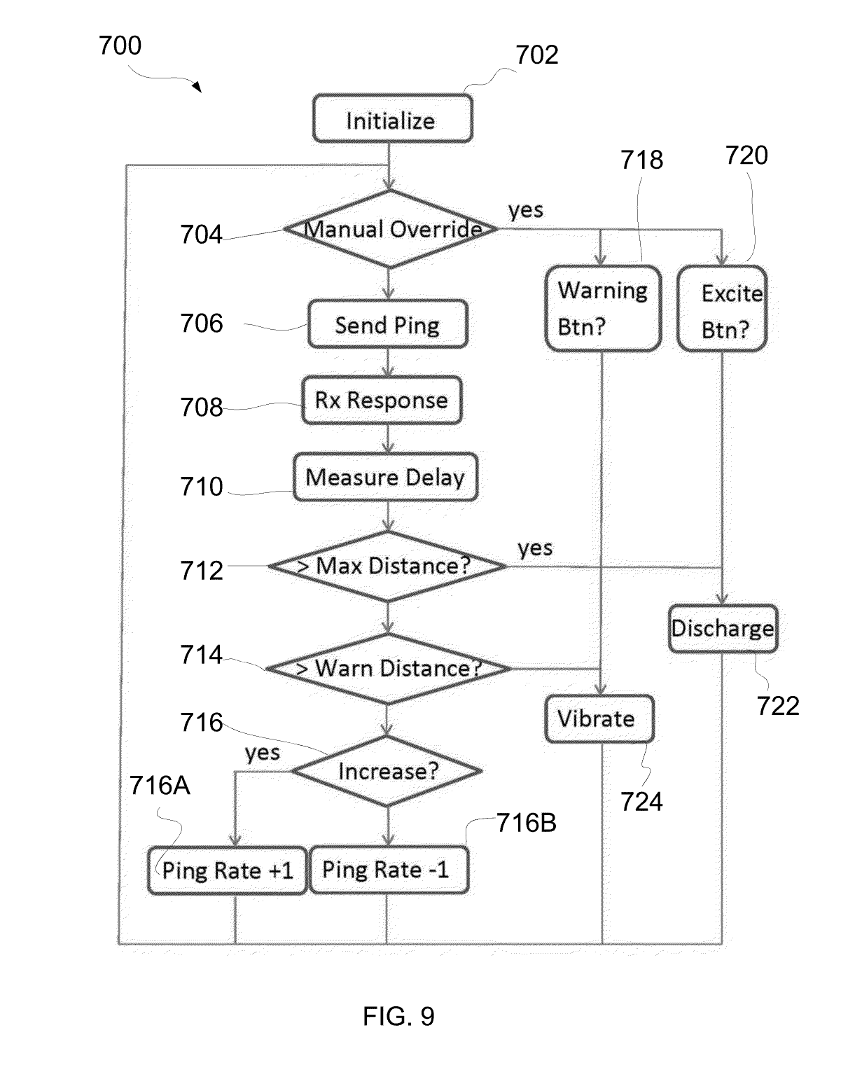

Referring now to FIG. 9, there is depicted a flow diagram for operation of a dog training system according to an embodiment of the present disclosure. When the collar 600 and the hand-held device 500 are powered on, they may undergo an initialization procedure at step 702. At step 704, the microprocessor 604 of the collar 600 determines whether a control signal has been received from the hand-held device 500. If yes, then at steps 718 and 720, the microprocessor 604 will determine whether to apply a warning signal, step 718, or an excite signal, step 720, based upon the control signal. If a warning signal has been received, then the microprocessor 604 may apply a vibration at step 724. If an excite signal has been received, then the microprocessor 604 may apply an excite signal at step 722.

If no control signal is received at step 704, then the microprocessor 604 at step 706 will send a wireless ping signal to the hand-held device 500. At step 708, the microprocessor 604 will received a wireless return signal from the hand-held device 500. At step 710, the microprocessor 604 measures the delay between the ping signal and the return signal. It will be appreciated that the delay represents a distance from the remote device and the collar 600. In this regard, the microprocessor 604 is able to determine the distance between the hand-held device 500 and the collar 600. If the distance exceeds a pre-determined and user specified maximum distance, then at step 722, microprocessor 604 may apply an electrical shock to the dog.

If the distance does not exceed a pre-determined maximum distance, the microprocessor 604 determines if the distance exceeds a warn distance at step 714. If the warn distance exceeds a pre-determined and user specified warn distance, then, at step 724, the microprocessor 604 may apply a warning signal to the dog.

If the distance does not exceed the warn distance, then at step 716, the microprocessor 604 determines the delay between the ping signal and the response signal is increasing. If the delay is increasing, then the microprocessor 604 increases the ping rate at step 716A. If the delay is decreasing, then the microprocessor 604 decreases the ping rate at step 716B. In this manner, the microprocessor 604 may conserve battery power.

In an alternative embodiment, the microprocessor 502 of the hand-held device 500 may transmit the ping signal. The collar 600 monitors for the ping from hand-held receiver 500. When the ping arrives, the collar 600 sends an ID response back immediately. This response is then received by the hand-held device and the time delay is measured for distance. Using a 30 MHz clock the distance can be measured to within a meter. If the distance (time) exceeds the maximum distance entered by a user and stored in a memory of the device 500 or collar 600, then the hand-held device 500 may transmit an excite or shock signal to the collar 600 which then applies the signal. If the distance (time) does not exceed the maximum distance but exceeds a warn distance, then the hand-held device 500 may transmit a warn signal to the collar 600 which then applies the signal.

If the dog is moving away from hand-held device 500, the ping rate is increased until the distance reaches a warning or excite condition. The ping rate is minimal for close ranges to save battery life. The hand-held device 500 and collar 600 can operate in manual mode, where warnings and excitations are controlled manually. The warning and excite ranges are set by user.

It will be appreciated that the above method allows a user to set a maximum distance between the hand-held device 500 and the collar 600. In this manner, a user may automatically control a distance to an animal.

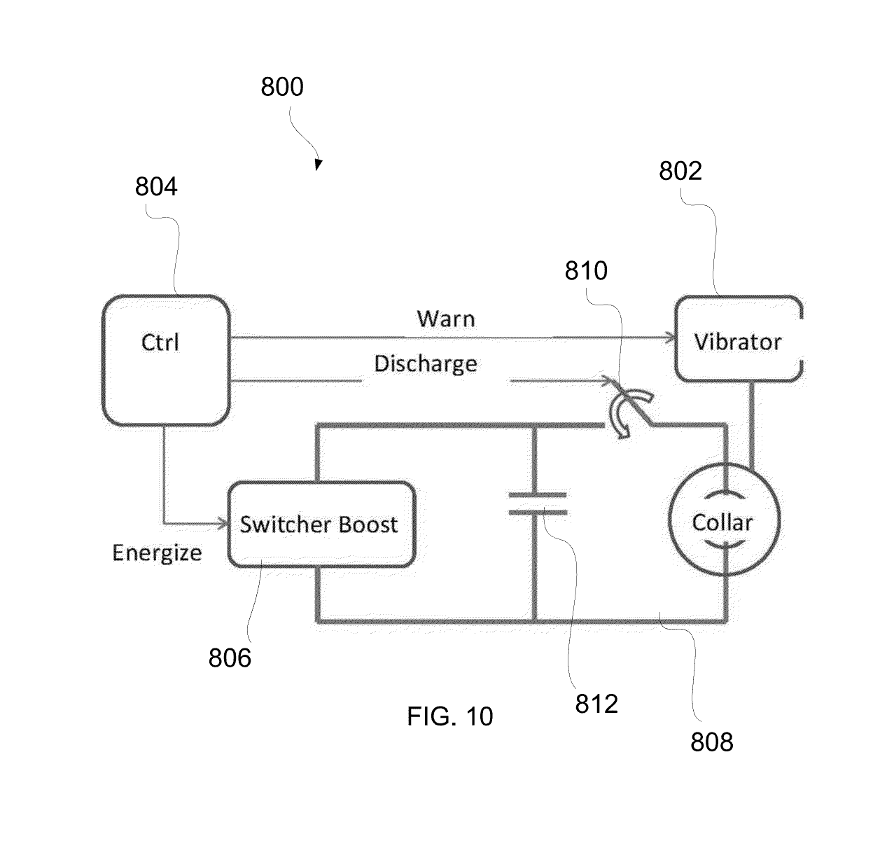

Referring now to FIG. 10, there is depicted a diagram of a collar circuit 800 according to an embodiment of the present disclosure. The circuit 800 may include a microprocessor 804 connected to a vibrator 802 and a stimulus circuit 808. The stimulus circuit 808 may comprise a switcher booster 806 and a switch 810 and a capacitor 812. The microprocessor 804 may be operable to apply a warning through the vibrator 802 or an electrical stimulus through the stimulus circuit 808.

In an embodiment, the present disclosure provides a dog training system, the system comprising: a dog collar having a waterproof housing; a microprocessor contained within the waterproof housing; at least one stimulator for applying a stimulus in response to a signal from the microprocessor; wherein said microprocessor is configured to provide the stimulus in response to (i) a command signal from a remote control; (ii) a signal from a bark sensor; and (iii) crossing a pre-defined boundary. The dog training system previously described, further comprising a hand-held remote device for use by a dog trainer, wherein the hand-held remote device is operable to transmit the command signal in response to a manual input by the dog trainer. The dog training system previously described, wherein the command signal indicates one of a command to apply an electric shock, a vibration, and an audible warning. The dog training system previously described, wherein the stimulus is selected from the group consisting of: an electric shock, a vibration, and an audible warning. The dog training system previously described, further comprising a rechargeable battery for providing power to the microprocessor. The dog training system previously described, wherein the microprocessor is configured to be operable in any one of, or all of, a remote training mode, a confinement mode, and an anti-bark mode. The dog training system previously described, further comprising a GPS receiver connected to the microprocessor. The dog training system previously described, further comprising a bark sensor connected to the microprocessor.

In an embodiment, the present disclosure provides a method of establishing an invisible boundary to control an animal, said method comprising: (i) installing a collar on the animal, the collar having a microprocessor, an antenna, a battery and at least one stimulator, the collar in wireless communication with a hand-held device; (ii) transmitting wireless ping signals and wireless response signals between the collar and the hand-held device; (iii) measuring delays between the ping signals and the response signals; and (iv) varying a ping rate of the ping signals in response to changes in the delay between the ping signals and the response signals. The method previously described, further comprising increasing the ping rate in response to an increase in the delay between the ping signals and the response signals. The method previously described, further comprising decreasing the ping rate in response to a decrease in the delay between the ping signals and the response signals. The method previously described, further comprising applying a first stimulus to the animal in response to the delay between a ping signal and a response signal exceeding a first pre-determined value. The method previously described, further comprising further comprising applying a second stimulus in response to the delay between a ping signal and a response signal exceeding a second pre-determined value. The method previously described, further comprising further comprising monitoring for a command signal. The method previously described, further comprising applying a stimulus in response to the command signal. The method previously described, wherein the stimulus is one an electric shock, a vibration, and an audible warning.

In an embodiment, the present disclosure provides a dog training system, the system comprising: a dog collar having a waterproof housing; a microprocessor contained within the waterproof housing; at least one stimulator coupled to the microprocessor for applying a stimulus in response to a signal from the microprocessor; an antenna coupled to the microprocessor; wherein the microprocessor is operable to receive ping signals from a hand-held device; and wherein the microprocessor is further operable to generate response signals in response to the ping signals. The dog training system previously described, further comprising a hand-held device having an antenna and a microprocessor, wherein the microprocessor of the hand-held device is operable to (i) generate the ping signals, and (ii) increase a ping rate in response to an increase in the delay between the ping signals and the response signals from the remote device. The dog training system previously described, wherein the microprocessor of the hand-held device decreases the ping rate in response to a decrease in the delay between the ping signals and the response signals. The dog training system previously described, wherein the microprocessor of the collar is operable to apply a first stimulus in response to the delay between a ping signal and a response signal exceeding a first pre-determined value.

It will be appreciated that the structure and apparatus disclosed herein is merely one example of a means for training a dog, and it should be appreciated that any structure, apparatus or system for training a dog which performs functions the same as, or equivalent to, those disclosed herein are intended to fall within the scope of a means for training a dog, including those structures, apparatus or systems for training a dog which are presently known, or which may become available in the future. Anything which functions the same as, or equivalently to, a means for training a dog falls within the scope of this element.

Those having ordinary skill in the relevant art will appreciate the advantages provide by the features of the present disclosure. For example, it is a feature of the present disclosure to provide a multifunction dog training collar. Another feature of the present disclosure to provide such a collar with a remote training mode, a confinement mode, and an anti-bark mode.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A dog training system, the system comprising:
a dog collar having a waterproof housing;
a microprocessor contained within the waterproof housing;
at least one stimulator for applying a stimulus in response to a signal from the microprocessor;
wherein said microprocessor is configured to provide the stimulus in response to (i) a command signal from a remote control; (ii) a signal from a bark sensor; and (iii) crossing a pre-defined boundary.

2. The dog training system of claim 1, further comprising a hand-held remote device for use by a dog trainer, wherein the hand-held remote device is operable to transmit the command signal in response to a manual input by the dog trainer.

3. The dog training system of claim 2, wherein the command signal indicates one of a command to apply an electric shock, a vibration, and an audible warning.

4. The dog training system of claim 1, wherein the stimulus is selected from the group consisting of: an electric shock, a vibration, and an audible warning.

5. The dog training system of claim 1, further comprising a rechargeable battery for providing power to the microprocessor.

6. The dog training system of claim 1, wherein the microprocessor is configured to be operable in any one of, or all of, a remote training mode, a confinement mode, and an anti-bark mode.

7. The dog training system of claim 1, further comprising a GPS receiver connected to the microprocessor.

8. The dog training system of claim 1, further comprising a bark sensor connected to the microprocessor.

9. A method of establishing an invisible boundary to control an animal, said method comprising:
installing a collar on the animal, the collar having a microprocessor, an antenna, a battery and at least one stimulator, the collar in wireless communication with a hand-held device;
transmitting wireless ping signals and wireless response signals between the collar and the hand-held device;
measuring delays between the ping signals and the response signals;
varying a ping rate of the ping signals in response to changes in the delay between the ping signals and the response signals.

10. The method of claim 9, further comprising increasing the ping rate in response to an increase in the delay between the ping signals and the response signals.

11. The method of claim 10, further comprising decreasing the ping rate in response to a decrease in the delay between the ping signals and the response signals.

12. The method of claim 9, further comprising applying a first stimulus to the animal in response to the delay between a ping signal and a response signal exceeding a first pre-determined value.

13. The method of claim 12, further comprising applying a second stimulus in response to the delay between a ping signal and a response signal exceeding a second pre-determined value.

14. The method of claim 9, further comprising monitoring for a command signal.

15. The method of claim 14, further comprising applying a stimulus in response to the command signal.

16. The method of claim 15, wherein the stimulus is one an electric shock, a vibration, and an audible warning.

17. A dog training system, the system comprising:
a dog collar having a waterproof housing;
a microprocessor contained within the waterproof housing;
at least one stimulator coupled to the microprocessor for applying a stimulus in response to a signal from the microprocessor;
an antenna coupled to the microprocessor;
wherein the microprocessor is operable to receive ping signals from a hand-held device; and
wherein the microprocessor is further operable to generate response signals in response to the ping signals.

18. The system of claim 17, further comprising a hand-held device having an antenna and a microprocessor, wherein the microprocessor of the hand-held device is operable to (i) generate the ping signals, and (ii) increase a ping rate in response to an increase in the delay between the ping signals and the response signals from the remote device.

19. The system of claim 18, wherein the microprocessor of the hand-held device decreases the ping rate in response to a decrease in the delay between the ping signals and the response signals.

20. The system of claim 19, wherein the microprocessor of the collar is operable to apply a first stimulus in response to the delay between a ping signal and a response signal exceeding a first pre-determined value.
